(19) United States
(12) Patent Application Publication
(10) Pub. No.: US 2012/0051305 A1
(43) Pub. Date: Mar. 1, 2012

(54) Method for Realizing Hybrid Automatic Retransmission Based on Persistent Scheduling

(75) Inventors: Junhu Wang, Guangdong Province (CN); Wenhuan Wang, Guangdong Province (CN); Bo Sun, Guangdong Province (CN); Yanfeng Guan, Guangdong Province (CN); Li Wang, Guangdong Province (CN)

(73) Assignee: ZTE CORPORATION, Guangdong Province (CN)

(21) Appl. No.: 13/259,587

(22) PCT Filed: Oct. 19, 2009
(86) PCT No.: PCT/CN09/74518

§ 371 Date: Oct. 14, 2011

(30) Foreign Application Priority Data
Apr. 14, 2009 (CN) 200910131677.8

(51) Int. Cl. H04W 74/04; H04W 72/04

(52) U.S. Cl. 370/329

(57) ABSTRACT

The present invention discloses a method for retransmitting hybrid automatic based on persistent scheduling. The method includes: a base station sending retransmission attribute information of a persistent scheduling service to a terminal by a control signaling. An HARQ mechanism under a persistent scheduling mode is perfected by defining a retransmission region of the persistent scheduling service, and retransmission data packets are centralized to be transmitted in the retransmission region at a synchronization time, which, compared with the prior art, saves the overhead of resource indication information indicating each retransmission packet.

### FIELD OF THE INVENTION

The present invention relates to communication field, and in particular to a method for realizing hybrid automatic retransmission based on persistent scheduling.

### BACKGROUND OF THE INVENTION

Hybrid automatic retransmission request (“HARQ” for short) is a technology put forward for overcoming influences of the wireless mobile channel time varying and multipath fading on the signal transmission. The technology is realized via a combined use of two technologies: automatic retransmission request (“ARQ” for short) and forward error correction (“FEC” for short) coding. Moreover, as one of the key technologies of the long term evolution (“LTE” for short) system of the 3^{rd} Generation Partnership Project (“3GPP” for short) and the world interoperability for microwave access (“WiMAX” for short), the HARQ technology is capable of allowing the wireless mobile communication system to obtain a higher system throughput and a higher system stability.

In the HARQ technology, the HARQ can be classified into two modes according to the retransmission format, i.e., adaptive HARQ and non-adaptive HARQ. The retransmission format herein includes modulation and coding mode, resource location, etc. The adaptive HARQ means that a sending end can modify part of the transmission format according to practical channel state information in each retransmission process, and as a result, control signaling information including the transmission format should be sent in each transmission process; and the non-adaptive HARQ means that transmission formats in the retransmission and in the first transmission are the same, or known to a receiving end in advance, and thus, there is no need to transmit control signaling information including the transmission format.

In the HARQ technology, the HARQ can be classified into synchronous HARQ and asynchronous HARQ on the basis of whether the retransmission timing being known in advance. Specifically, the retransmission of the synchronous HARQ is defined at a predefined time, and no signaling is needed to indicate the retransmission time during the retransmission; while the retransmission of the asynchronous HARQ can be performed at any time, thus, a signaling is needed to indicate the retransmission time during each retransmission.

Obviously, the synchronous non-adaptive HARQ has an advantage of saving the signaling overhead, while the asynchronous adaptive HARQ has an advantage of flexible scheduling.

Persistent scheduling means that resource blocks are allocated periodically, in a certain time range, to fixed users to be adapted to some periodic services having payloads with a fixed size, such as voice over Internet protocol (“VoIP” for short) service. The system overhead brought by mapping information of the resources can be saved through the persistent scheduling. During a valid period of the persistent scheduling, the resources and modulation and coding mode for transmitting the persistent service data each time is constant and unchanged until the persistent allocation is cancelled.

FIG. 1 is a schematic diagram of a persistent scheduling region in a time division duplex-orthogonal frequency division multiplexing (“TDD-OFDM” for short). As shown in FIG. 1, regions shown by grids with oblique lines are resources for downlink persistent scheduling, and regions shown by grids with perpendicular and horizontal lines are resources for uplink persistent scheduling. One radio frame consists of eight subframes, a period of the persistent scheduling is allocated every four radio frames, and a transmission region allocated to the persistent scheduling service is called a persistent allocation region (“PAR” for short).

At present, it is prescribed that the resources allocated and the modulation and coding mode for each transmission of new data of the persistent scheduling service is unchanged in the service process, but a non-persistent scheduling mode, i.e., adaptive HARQ, is used in the prior art for retransmission of the persistent scheduling service data, as a result, a base station needs to re-allocate the resources for each retransmission data packet and indicate a transmission format thereof, which leads to a big signaling overhead.

### SUMMARY OF THE INVENTION

The present invention is made upon considering the problem of a big system overhead caused by the non-persistent resource scheduling mode in the retransmission region for the hybrid automatic retransmission of the persistent scheduling service in related art, thus the main object of the present invention lies in providing a method for retransmitting hybrid automatic based on persistent scheduling so as to solve the problem.

A method for realizing hybrid automatic retransmission based on persistent scheduling is provided according to one aspect of the present invention.

The method for realizing hybrid automatic retransmission based on persistent scheduling according to the present invention comprises: a base station sending retransmission attribute information of a persistent scheduling service to a terminal by a control signaling.

In the above, the retransmission attribute information comprises at least one of attribute information of a retransmission region, retransmission bitmap indicator information and adaptability indicator information.

Further, prior to the base station sending the retransmission attribute information to the terminal, the method further comprises: the base station sending persistent allocation mapping elements of the persistent scheduling service to enable the terminal to receive or send initial transmission data packets in a persistent scheduling region, wherein the persistent allocation mapping elements carry the number of logical resource units occupied by each initial transmission data packet; and the terminal that receives or sends the initial transmission data packets in a persistent allocation mode in the persistent scheduling region, storing a corresponding relation between an indicator of the each initial transmission data packet received or sent in the persistent allocation mode in the persistent scheduling region and the number of the logical resource units occupied by the each initial transmission data packet.

In the above, the attribute information of the retransmission region comprises a predetermined indicator bit which is set to be a first predetermined field if the base station does not need to re-allocate the retransmission region, to indicate that a starting location of the retransmission region is the same as a frequency domain starting location of the persistent scheduling region.

In the above, the predetermined indicator bit is set to be a second predetermined field if the base station needs to re-allocate the retransmission region, to indicate that the starting location of the retransmission region is not the same as the starting location of the persistent scheduling region.

In the above, the attribute information of the retransmission region further comprises following parameter information: the starting location of the retransmission region and the number of the logical resource units occupied by the retransmission region, wherein the starting location comprises at least one of an index of a first logical resource unit occupied by the retransmission region and a subframe offset of the first logical resource unit occupied by the retransmission region.

In the above, the attribute information further comprises following parameter information: identification number of the retransmission region.

In the above, the adaptability indicator comprises a predetermined indicator bit which is set to be a third predetermined field to indicate that an attribute of a retransmission data packet is the same as that of a corresponding initial transmission data packet, wherein the attribute of the initial transmission data packet comprises at least one of a modulation and coding mode of the data packet and the number of logical resource units occupied.

Further, after the base station sending the retransmission attribute information, the method further comprises: the terminal that has received informed retransmission attribute information, determining a location occupied by the terminal in the retransmission region for receiving or sending the retransmission data packet according to the corresponding relation stored thereby and the retransmission bitmap indicator information.

In the above, the adaptability indicator comprises a predetermined indicator bit which is set to be a fourth predetermined field to indicate whether an attribute of a retransmission data packet is not the same as that of a corresponding initial transmission data packet, and then the retransmission attribute information further comprises attribute change information of retransmission data, wherein the attribute change information of the retransmission data comprises at least one of the number of the logical resource block occupied by each retransmission data packet and a modulation and coding mode indicator of the each retransmission data packet.

Further, after the base station sending the retransmission attribute information, the method further comprises: the terminal that has received the retransmission attribute information determining a location in the retransmission region where the terminal receives or sends the retransmission data packet according to the retransmission bitmap indicator information and the attribute change information of the retransmission data.

In the above, the attribute information of the retransmission data further comprises at least one of an offset of a starting location of a each retransmission data packet with respect to the starting location of the retransmission region, a version number of the each retransmission data packet and an identifier of a terminal corresponding to the each retransmission data packet.

In the above, the terminal is one or more terminals performing the persistent scheduling service.

In the above, the retransmission region is located on a designated subframe of a synchronous HARQ in the time domain.

In the above, the retransmission region is configured to transmit data packets that failed to be transmitted by the persistent scheduling service.

Preferably, the control signaling comprises at least one of persistent allocation retransmission resource mapping information elements in a resource allocation mapping message and persistent allocation resource mapping information elements in the resource allocation mapping message.

With at least one of the above technical solutions of the present invention, an HARQ mechanism under the persistent scheduling mode is perfected by defining the retransmission region of the persistent scheduling service, and the retransmission data packets are centralized to be transmitted in the retransmission region at a synchronization time, which, compared with the prior art, saves the overhead of the resource indication information for indicating respective retransmission packet.

### BRIEF DESCRIPTION OF THE DRAWINGS

The accompanying drawings, constituting a part of the Description for further understanding the present invention, illustrate the present invention together with the embodiments of the present invention without limiting the present invention. In the drawings:

FIG. 1 is a schematic diagram of a resource division of persistent scheduling;

FIG. 2 is a flowchart of a method for retransmitting hybrid automatic based on the persistent scheduling according to a method embodiment of the present invention;

FIG. 3 is a schematic diagram of a persistent scheduling region and retransmission regions according to an application example of the present invention;

FIG. 4 is a schematic diagram of another type of a persistent scheduling region and retransmission regions according to an application example of the present invention;

FIG. 5 is a schematic diagram of location indication relations between data packets in a persistent scheduling region and retransmission regions according to an application example of the present invention;

FIG. 6 is a schematic diagram of resource holes formed in a retransmission region according to an application example of the present invention; and

FIG. 7 is a schematic diagram of a retransmission resource cascade according to an application example of the present invention.

### DETAILED DESCRIPTION OF EMBODIMENTS

Functional Overview

The persistent scheduling will be introduced before embodiments of the present invention are described.

For the persistent scheduling service, the base station will allocate a fixed resource block (i.e., persistent scheduling region) for an initial transmission data of the service, and periodically allocates the persistent scheduling region, in a predetermined time range, to one or more users using the persistent scheduling service. Resources and modulation and coding mode of the persistent scheduling are unchanged during a valid period of the persistent scheduling until the persistent allocation is cancelled. Generally, the persistent scheduling service such as VoIP service has the characteristics of strong periodicity and payloads with a fixed size.

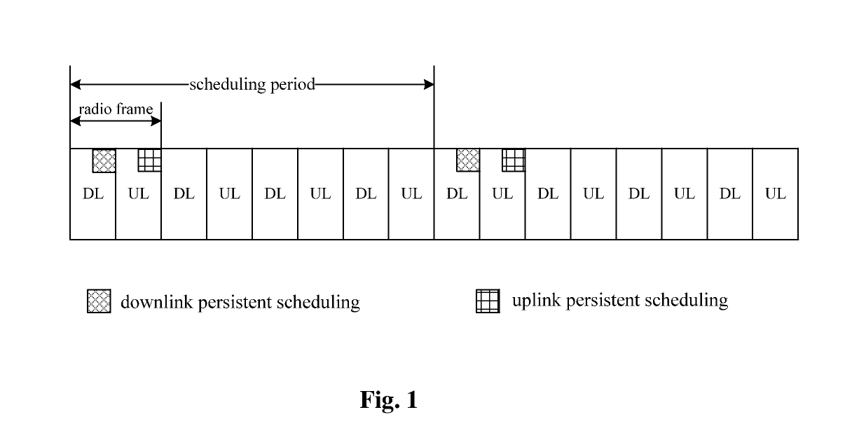

For the persistent scheduling service, the data of the user is scheduled periodically, as shown in FIG. 1 where one persistent scheduling period is four radio frames. After a lapse of one scheduling period, the resources in this location are persistently allocated to a corresponding user until the user cancels the service. As a result, it is unnecessary to make a resource allocation indication each time, while there is only the need of initiating the allocation and ending the allocation, and indicating the valid period of the allocation.

At present, the resources of the retransmission data of the persistent scheduling service are dynamically allocated, and the base station needs to send the resources allocation information of each retransmission packet, which leads to a big system overhead. Regarding this problem, the present invention provides a hybrid retransmission solution for the persistent scheduling in a manner of sending retransmission data packets in the region and taking the characteristics of attribute adaptability of the retransmission data packets into simultaneous consideration. The solution has the characteristics of a small overhead and high flexibility.

It should be indicated that the embodiments of the present application and features thereof can be combined with each other if no conflict is caused. The present invention will be described in detail with reference to the figures in conjunction with the embodiments.

### Method Embodiments

A method for realizing hybrid automatic retransmission based on persistent scheduling is provided according to embodiments of the present invention. The method can be applied to a TDD-OFDM system.

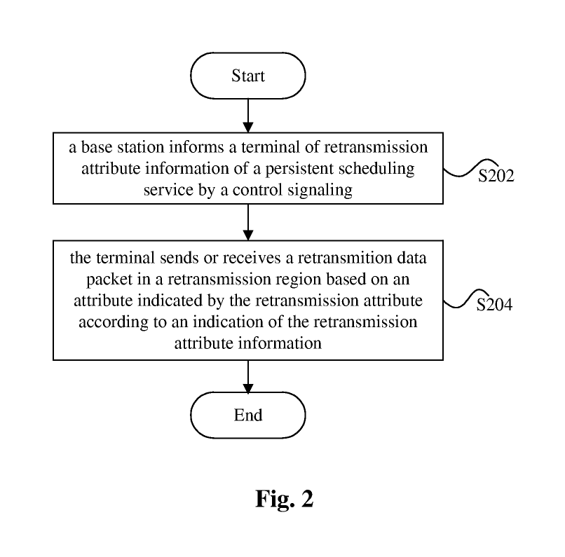

FIG. 2 is a flow chart of a method for realizing hybrid automatic retransmission based on the persistent scheduling according to an embodiment of the present invention. It should be indicated that, for the sake of easy description, a technical solution of a method embodiment of the present invention is shown and described as steps in FIG. 2. The steps shown in FIG. 2 can be implemented in a computer system with, for instance, a set of computer executable instructions. Though a logical order is shown in FIG. 2, the steps shown or described can be implemented in an order different from that herein in some cases. As shown in FIG. 2, the method mainly includes the following steps (Step S202 to Step S204).

Step S202, a base station informs a terminal of retransmission attribute information of a persistent scheduling service by a control signaling, wherein the retransmission attribute information can comprise attribute information of a retransmission region, retransmission bitmap indicator information and adaptability indicator information, wherein the retransmission region is configured to transmit data packets that failed to be transmitted by the persistent scheduling service, and the retransmission region is located on a designated subframe of a synchronous HARQ in the time domain, the terminal above is one or more terminals performing the persistent scheduling service; moreover, the control signaling can comprise one of uplink/downlink basic resource allocation mapping information elements and uplink/downlink persistent allocation retransmission resource mapping information elements.

Step S204, the terminal sends or receives a retransmission data packet in the retransmission region based on an attribute indicated by the retransmission attribute according to an indication of the retransmission attribute information, wherein the terminal sends the data packet when the persistent service is uplink, and the terminal receives the data packet when the persistent service is downlink.

Technical features of the present invention will be described in detail taking uplink transmission as an example.

Step 1, the base station informs the terminal, via uplink persistent allocation mapping elements, to send data to the base station in the persistent allocation region, wherein the uplink persistent allocation mapping elements can comprise location information of the persistent allocation region and attribute information of transmission data packets of respective terminals, wherein the data packet attribute information comprises a location and size of resources occupied by a data packet in the persistent allocation region, and transmission format information. The transmission format information can comprise information such as a modulation and coding mode, a HARQ channel number and a coding sub-packet serial number. It should be indicated that the terminals above are one or more terminals performing the persistent scheduling service, and the base station can send the uplink persistent allocation mapping elements to each of the terminals performing the persistent scheduling service. See Table 1 for specific uplink persistent allocation mapping elements.

TABLE 1

| Syntax | Description |
|---|---|
| UL Persistent Allocation | uplink persistent allocation |
| A-MAP IE ( ) { | mapping element |
| A-MAP type | ID type of the mapping |
| | information element |
| Number of allocations | the number of the persistent |
| | service data packets allocated to |
| | the region |
| Persistent Region ID | persistent region ID number |
| . . . | |
| While (data remaining) | following allocation is made when |
| { | there is a data packet |
| Region ID use indicator | whether the region ID is |
| | used |
| if (Region ID use indicator ==0) | following definition is made |
| { | when the region ID is not used |
| Region information | definitions of location and |
| | size of a region |
| } | when the region ID is used |
| Else | |
| { | |
| Region ID | region identifier predefined in an |
| | Secondary superframe head |
| } | |
| For (j=0;j<Number of | allocation indicator of |
| allocations; j++) { | respective transmission packets |
| STID | (compacted) user ID |
| | number |
| LRU offset | offset of data packet resources in a |
| | persistent allocation region, taking |
| | LRU as the unit |
| Duration | resource size, i.e., the number of |
| | logical resource units occupied by |
| | the resource allocations |
| MCS | indicate a modulation and coding |
| | mode, explicitly |
| ACID | HARQ channel number |
| SPID | code a sub-packet serial |
| | number (optional) |
| CoRE Version | constellation reordering |
| | version (optional) |
| . . . | |
| } | |
| . . . | |
| } | |

Step 2, each terminal, upon receiving the uplink persistent allocation mapping elements, sends an initial transmission data over corresponding resources according to corresponding data packet attributes based on the indication thereof.

Further, the terminal can further determine and store a corresponding relation (which also can be called a persistent region structure) between the indicator of each initial transmission data packet and the number of the logical resource units occupied by the initial transmission data packet according to the persistent allocation mapping elements. The persistent region structure is updated according to the period of the persistent allocation. Generally, the persistent allocation takes four radio frames or 20 ms as one period. A terminal having a transmission service in the persistent allocation region can store the persistent region structure, as shown in Table 2, and the persistent region structure will be updated with the updating of Table 1.

That is, each terminal having the transmission service in the persistent allocation region needs to store the LRU offset and duration for its own STID in the present information elements, and also needs to store the durations, i.e., resource sizes (i.e. the number of LRUs) of all the other terminals. Each terminal stores the persistent allocation structure by receiving the persistent allocation region information elements, as shown in Table 2.

TABLE 2

| Indicator of Initial Transmission | LRU Number (number of the logical |
|---|---|
| Data Packet | resource units) |
| 1 | N1 |
| 2 | N2 |
| 3 | N3 |
| 4 | N4 |
| . . . | . . . |

Step 3, the base station, upon receiving the initial transmission data sent from each terminal, can send the retransmission attribute information of the persistent scheduling allocation service above to the each terminal by the control signaling according to the situation of receiving each data packet, wherein the retransmission attribute information can comprise retransmission region attribute information, retransmission bitmap indicator information and an adaptability indicator, and the control signaling can comprise one of the uplink persistent allocation retransmission resource mapping information elements in the resource allocation mapping message, and the uplink persistent allocation resource mapping information elements in the resource allocation mapping message. The embodiment of the present invention will be described by taking the uplink persistent allocation retransmission resource mapping information elements in the retransmission attribute information as an example. See Table 3 for specific uplink persistent allocation mapping information elements.

TABLE 3

| Syntax | Description |
|---|---|
| ULPA Retransmission A-MAP IE ( ) | uplink persistent allocation |
| { | retransmission mapping information |
| | element |
| AMAP type | mapping information type |
| Persistent Region ID | persistent region ID |
| Retransmission region change indictor | Indicator of changes to a |
| | retransmission region |
| | 0: representing it is the same |
| | with a starting location of a PA region |
| | 1: representing a new region |
| If (HARQ region change indictor==1) | If an HARQ region indicator is |
| { | 1, it means to indicate a new |
| | region, explicitly. |
| Region ID use indicator | region ID indicator |
| | 0: a predefined region is not |
| | used |
| | 1: a predefined region is used |
| if (Region ID use indicator ==0) | |
| { | |
| Subframe offset | subframe offset (optional) |
| LRU Index | index or serial number of a |
| | logical resource unit |
| LRU number | the number of the logical |
| | resource units represents their sizes |
| } | — |
| Else | |
| { | |
| Region ID | region ID |
| } | — |
| } | |
| Retransmission Bitmap Index | retransmission bitmap indicator |
| ACK Region Index | feedback channel region |
| | indicator (optional) |
| Retransmission adaptability indicator | retransmission adaptability |
| | indicator |
| | 0: retransmission is |
| | non-adaptability |
| | 1: retransmission is |
| | adaptability |
| If ( Retransmission adaptability indicator | adaptively transmit each |
| ==1 ) | retransmission packet and indicate |
| { | attributes such as modulation and |
| | coding mode, resource allocation of |
| | the each retransmission packet, etc. |
| For (j=0;j<Number of retransmission | indicate attributes of each |
| allocations; j++) { | retransmission data packet, |
| | respectively, wherein the number of |
| | the transmission packets is the same |
| | with the number of the retransmission |
| | data packets indicated by the |
| | retransmission bitmap index |
| STID | terminal ID number (possibly |
| | omitted) |
| MCS | modulation and coding mode |
| | indicator |
| LRU number | the number of the logical resource |
| | units occupied by time frequency |
| | resources allocated for the data packet |
| SPID | version number of the |
| | retransmission packet |
| . . . | |
| } | |
| } | |
| . . . | |
| } | |

Next, the retransmission region attribute information, retransmission bitmap indicator information and adaptability indicator will be described respectively in conjunction with Table 3.

(I) Retransmission region information: configured to indicate a location of the retransmission region in the subframe, and comprising a retransmission region change indicator (i.e., the attribute information of the retransmission region comprising the predetermined indicator bit as mentioned above) and a persistent region ID (which is configured to indicate an ID number of a persistent allocation region corresponding to the present retransmission region).

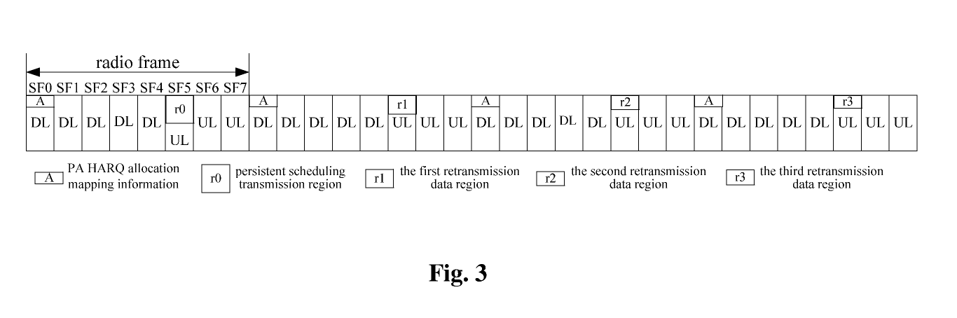

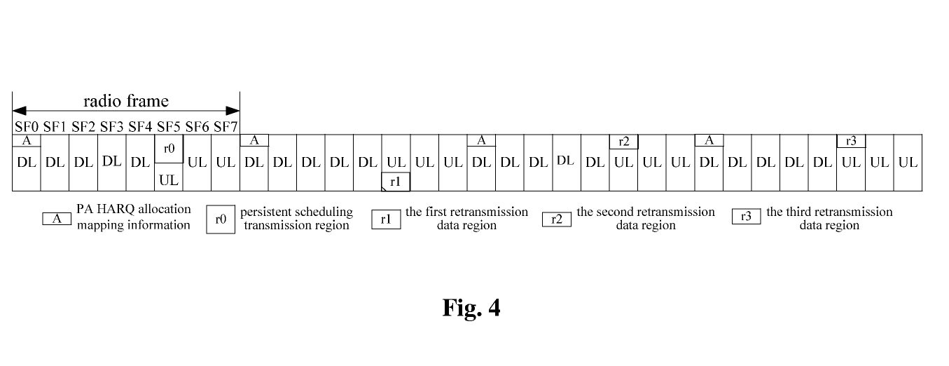

The retransmission region change indicator is configured to indicate whether the location of a retransmission region in the subframe is the same as that of the persistent allocation region. For instance, if its value is “0” (state 1), it means that the location of the retransmission region in the subframe is the same as that of the persistent allocation region, and it is unnecessary to indicate the location of the retransmission region, as shown in FIG. 3 where locations of retransmission regions corresponding to a persistent allocation region r0 in the each subframe are the same, that is, starting locations of r1, r2, r3 and r0 being the same; and if the value is “1” (state 2), it means that the location of a retransmission region in the subframe is different from that of the persistent allocation region, and as a result, the location of the retransmission region in the subframe needs to be indicated in a subsequent field, as shown in FIG. 4 where the starting location of a retransmission region r1 corresponding to a persistent allocation region r0 is different from that of r0, while the starting locations of r2, r3 and r4 are the same as that of r0, therefore, the location information of r1 should be indicated in the persistent retransmission information elements. Of course, the value of the retransmission region change indicator also can be other values, and a corresponding relation between the value and a meaning expressed thereby also can be different from the descriptions above. Only examples are given herein, other situations are similar, and unnecessary details will not be given.

Further, there are two situations as follows where the location of a retransmission region in the subframe is different from that of the persistent allocation region.

Situation 1: if a predefined semi-static region is used, an ID number of the retransmission region needs to be indicated in the retransmission region information, and a region ID is configured to indicate the ID number of the retransmission region. For example, a value of region ID use indicator can be 1 (state 2) for indicating that the predefined semi-static region is used.

Situation 2: if a dynamically allocated region is used, the location and size of the retransmission region need to be indicated in the retransmission region information, wherein the location information comprises an index of a first logical resource unit occupied by the retransmission region or a serial number of the first logical resource unit occupied by the retransmission region, and/or a subframe offset of the first logical resource unit occupied by the retransmission region. At this time, the value of the region ID use indicator can be 0 (state 1) for indicating that the dynamically allocated region is used.

The value of the region ID use indicator herein also can be other values, and a corresponding relation between the value and a meaning expressed thereby also can be different from descriptions above, and examples will not be listed herein one by one.

(II) Retransmission Bitmap Indicator Information

The retransmission bitmap indicator information indicates a situation of receiving a data packet transmission in a persistent retransmission allocation region, and is formed by ACK (acknowledgement) or NACK (negative acknowledgement) information fed back from a base station or terminal for each data packet (including initial transmission data packets and retransmission data packets).

(III) Adaptability Indicator

The adaptability indicator comprises a predefined indicator bit which is set to be a third predefined field to indicate whether an attribute of a retransmission data packet is the same as that of a corresponding initial transmission data packet. Accordingly, after the base station informing the retransmission attribute information, each terminal that has received the informed retransmission attribute information determines a location occupied by the terminal in the retransmission region for receiving and/or sending the retransmission data packet according to the corresponding relation stored thereby and the retransmission bitmap indicator information.

The predetermined indicator bit is set to be a fourth predetermined field to indicate whether the attribute of a retransmission data packet is not the same as that of a corresponding initial transmission data packet, and then the retransmission attribute information further comprises attribute change information of retransmission data, wherein the attribute change information of the retransmission data can comprise at least one of the number of the logical resource blocks occupied by each retransmission data packet, a modulation and coding mode indicator of each retransmission data packet, an offset of a starting location of each retransmission data packet with respect to a starting location of the retransmission region, a version number of each retransmission data packet and an identifier of a terminal corresponding to each retransmission data packet. Consequently, after the base station informing the retransmission attribute information, each terminal that has received the informed retransmission attribute information determines a location occupied by the terminal in the retransmission region for receiving and/or sending the retransmission data packet according to the retransmission bitmap indicator information and the attribute change information of the retransmission data.

For example, the retransmission adaptability indicator is a retransmission adaptability indicator field to indicate whether the format of a retransmission data packet is adaptive. The format of the retransmission data packet is adaptive when the retransmission adaptability indicator is 1 (state 2); and the format of the retransmission data packet is non-adaptive when the retransmission adaptability indicator is “0” (state 1). The value of the retransmission adaptability indicator herein also can be other values, and a corresponding relation between the value and a meaning expressed thereby also can be different from the descriptions above, and examples will not be listed herein one by one.

Step 4: each terminal, upon having received the uplink persistent allocation retransmission mapping elements, will determine the location of the retransmission region according to the retransmission region information, determine the data packet requiring retransmission according to the retransmission bitmap indicator, and determine whether the attribute information of the retransmission data is the same as that of the initial transmission data according to the adaptability indicator. If the attribute information is the same, the terminal that needs to retransmit the data will determine a location of the retransmission data packet thereof in the retransmission region according to Table 4 it stores and the retransmission bitmap indicator; and if not, the retransmission attribute information still needs to carry the attribute information of the retransmission data packet. Consequently, the terminal that needs to retransmit the data will determine a location of the retransmission data packet thereof in the retransmission region according to the attribute information of the retransmission data packet and the retransmission bitmap indicator.

Next, the retransmission format of the data packets will be described when the attribute information is the same or not.

Format 1: the attribute information is the same.

Table 4 below is an example of the persistent region structure shown in Table 2 in Step 2, wherein the numbers of the logical resource units in Table 4 are merely examples without a practical meaning.

TABLE 4

| | LRU Number (each LRU comprises 18 |
|---|---|
| Persistent Allocation Index | sub-carriers and six OFDMA symbols) |
| 0 | 2 |
| 1 | 2 |
| 2 | 2 |
| 3 | 2 |
| 4 | 3 |
| 5 | 3 |
| 6 | 3 |

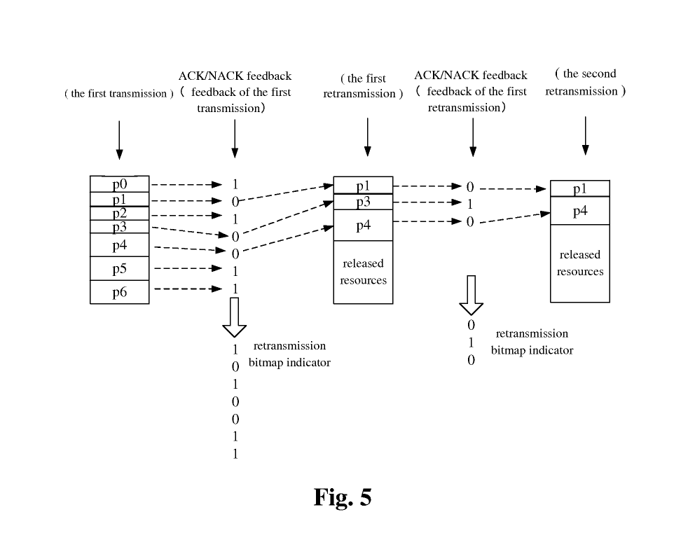

As shown in FIG. 5, the initial transmission data packets allocated to the persistent region are p0-p7. After the base station receives p0-p7, data packets incorrectly received are p1, p3 and p4; thus a retransmission bitmap indicator is 1010011, wherein “0” represents incorrectly receiving, i.e., retransmission is needed, and “1” represents correctly receiving, i.e., retransmission is not needed. The retransmission data packets are in a cascading arrangement in the persistent retransmission region to eliminate resource holes formed by successful transmission. The arrangement of the data packets are p1, p3 and p4 in a first retransmission region corresponding to the persistent allocation; and the terminal determines the starting location of each retransmission data packets in the retransmission region according to the persistent allocation structure Table 4 and the retransmission bitmap indicator, as shown in Table 5 below.

TABLE 5

| | Relative Starting Location (taking LRU as |
|---|---|
| Data Packet | the unit) |
| P1 | 0 |
| P3 | 2 |
| P4 | 4 |

Similarly, assume that a retransmission bitmap indicator of a second retransmission is 1011011, the arrangement of the data packets is p1 and p4 in the second retransmission region corresponding to the persistent allocation, and the terminal determines the starting locations of each retransmission data packet in the retransmission region according to the persistent allocation structure Table 4 and the retransmission bitmap indicator 1011011, as shown in Table 6.

TABLE 6

| | Relative Starting Location (taking LRU as |
|---|---|
| Data Packet | the unit) |
| P1 | 0 |
| P4 | 2 |

Format 2: the attribute information is not the same.

Further, when the retransmission adaptability indicator is “1” (state 2), i.e., a format of retransmitting a data packet is adaptive, the transmission format of each retransmission data packet should be defined one by one in persistent retransmission allocation information elements, wherein the transmission format can comprise at least one of the number of the logical resource blocks occupied by each transmission data packet, a modulation and coding mode indicator of each retransmission data packet, an offset of the starting location of each retransmission data packet with respect to the starting location of the retransmission region, a version number of each retransmission data packet, and an identifier of a terminal corresponding to each retransmission data packet. As a result, after the base station informing the retransmission attribute information, each terminal that has received the informed retransmission attribute information determines a location occupied by the terminal in the retransmission region for receiving and/or sending the retransmission data packet according to the retransmission bitmap indicator information and the attribute change information of the retransmission data.

Next, processes of forming the retransmission bitmap indicator and bitmap will be further described.

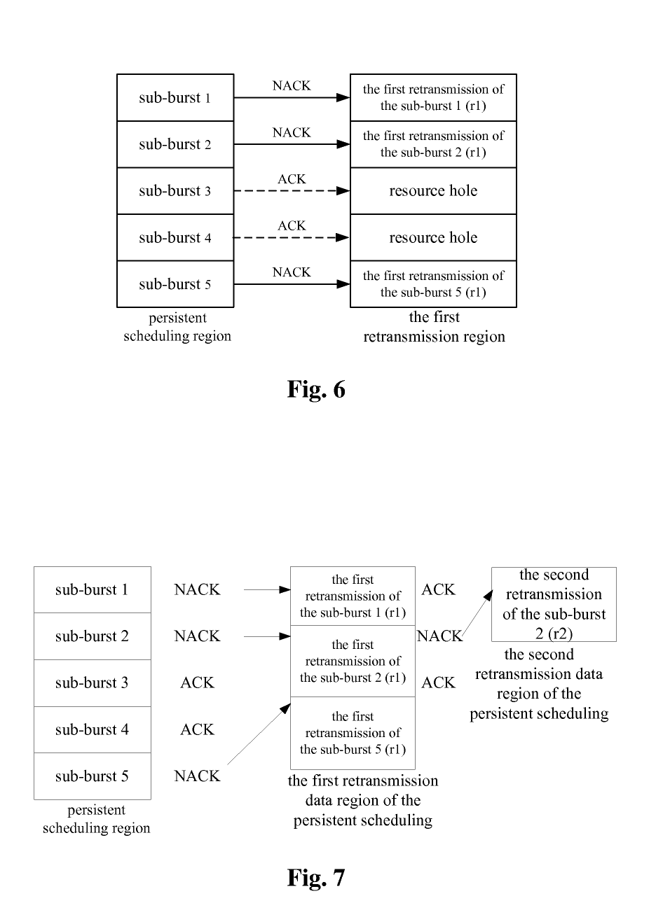

Retransmission bitmap indicator: in the schematic diagrams shown in FIG. 3 or FIG. 4, resource holes can be compensated in a manner of sequentially shifting the sub-bursts (i.e., the data packets mentioned above) in the retransmission regions r1, r2 and r3. When a feedback is ACK, it means that the sub-burst has been sent successfully and does not need to be retransmitted, while a resource hole is formed in a location corresponding to the sub-burst in the retransmission region. For instance, as shown in FIG. 6, there are five sub-bursts in a persistent scheduling region, and after they are sent to a terminal, the terminal feeds back ACK/NACK information, wherein the feedback information of the sub-bursts 1, 2 and 5 is NACK, and the feedback information of the sub-bursts 3 and 4 is ACK, i.e., the sub-bursts 1, 2 and 5 are retransmitted in the first retransmission region, resource holes will be formed in locations corresponding to the sub-bursts 3 and 4, and the sub-bursts 1, 2 and 5 will fill up the resource holes formed by the sub-bursts 3 and 4. Specifically, retransmission locations of the sub-bursts 1, 2 and 5 are unchanged, and the sub-burst 5 will retransmit the data on the resource hole formed by the sub-burst 3. A specific processing manner is as shown in FIG. 6.

Bitmap: FIG. 7 is a schematic diagram of a retransmission resource cascade, showing a mapping relation of sub-bursts in retransmission regions. As shown in FIG. 7, the feedback information obtained by each sub-burst constitutes an index sequence 11001 (assume that NACK is “1”, and ACK is “0”) in the persistent region, the base station informs all terminals of the feedback index bitmap in the retransmission mapping information of the persistent scheduling, and this field is called a first retransmission sub-burst mapping bitmap; at the same time, the base station informs all terminals of the number of time slots occupied by each sub-burst. The base station retransmits the sub-bursts that are “1” in the feedback index bitmap, and eliminates the resource holes generated by the sub-bursts that are “0” in the feedback index bitmap by means of time slot displacement; and the retransmission sub-bursts, after the time slot displacement, are combined into a whole resource block.

The terminal reads feedback index Bitmap information corresponding to the sub-burst needing to be received in the retransmission mapping information of the persistent scheduling, and if a feedback bit of a sub-burst corresponding to it is “1”, it means that there is a retransmission sub-burst in a corresponding location of the first retransmission region; similarly, the sub-burst in the retransmission region in respective time is ordered takes ACK/NACK information of the sub-burst in the previous retransmission region fed back by a receiving end as an index, and the base station indicates the index and the number of the time slots occupied by each sub-burst to all terminals in a bitmap manner in the retransmission mapping.

As a result, the retransmission overhead can be reduced via regional retransmission of the sub-bursts in the persistent scheduling region by mapping the retransmission resources with the feedback index bitmap information. And at the same time, the retransmission region can be flexibly defined, the resources are reasonably utilized, and the resource utilization ratio is improved.

With the technical solutions provided in the embodiments of the present invention, an HARQ mechanism under the persistent scheduling mode is perfected by defining the retransmission regions of the persistent scheduling service, and the retransmission data packets are centralized to be transmitted in the retransmission regions at a synchronization time, which, compared with the prior art, saves the overhead of the resource indication information for indicating each retransmission packet.

According to an embodiment of the present invention, a computer readable medium is further provided. The computer readable medium stores computer executable instructions, allowing a computer or processor to implement processes of step S202 and step S204 shown in FIG. 2 when the instructions are implemented by the computer or processor. Preferably, one or more embodiments above can be implemented.

In addition, the present invention realized without modifying the system architecture or current processing flow, is easy to be implemented and popularized in the art, and has strong industrial applicability.

Apparently, the person skilled in the art should know that each module unit or step of the present invention can be realized by the general calculating apparatus; they can be collected in a single calculating apparatus or distributed on the network formed by a plurality of calculating apparatus. Optionally, they can be realized by the program codes executable by the calculating apparatus, therefore, they can be stored in the storing apparatus to be executed by the calculating apparatus, or they can be fabricated into integrated circuit modules, respectively, or a plurality of modules or steps therein are fabricated into individual integrated circuit module for the accomplishment. Thus, the present invention is not limited to combination of any particular hardware and software.

As mentioned above, with the method for realizing hybrid automatic retransmission based on the persistent scheduling provided in the present invention, the HARQ mechanism under the persistent scheduling mode is perfected by defining the retransmission regions. When the HARQ is synchronous, the overhead of the resource indication information indicating each retransmission data packet is saved by centralizing the retransmission data packets to be transmitted in the retransmission region at a synchronization time; moreover, a mechanism of re-allocation indication of the retransmission region is provided when the predetermined retransmission resource is unavailable, which can avoid the resource conflict.

The above mentioned is merely the preferred embodiments of the present invention but not to limit the present invention. Various alterations and changes to the present invention are apparent to the person skilled in the art. Any modifications, equivalent substitutions, improvements etc. within the spirit and principle of the present invention should be concluded in the scope protected by the present invention.

1. A method for realizing hybrid automatic retransmission based on persistent scheduling, characterized by comprising:
a base station sending retransmission attribute information of a persistent scheduling service to a terminal by a control signaling, wherein the terminal is one or more terminals performing the persistent scheduling service.

2. The method according to claim 1, wherein the retransmission attribute information comprises at least one of attribute information of a retransmission region, retransmission bitmap indicator information and adaptability indicator information.

3. The method according to claim 2, wherein prior to the base station sending the retransmission attribute information to the terminal, the method further comprising:
the base station sending persistent allocation mapping elements of the persistent scheduling service to enable the terminal to receive or send initial transmission data packets in a persistent scheduling region, wherein the persistent allocation mapping elements carry the number of logical resource units occupied by each initial transmission data packet; and
the terminal that receives or sends the initial transmission data packets in a persistent allocation mode in the persistent scheduling region, storing a corresponding relation between an indicator of the each initial transmission data packet received or sent in the persistent allocation mode in the persistent scheduling region and the number of the logical resource units occupied by the each initial transmission data packet.

4. The method according to claim 3, wherein the attribute information of the retransmission region comprises a predetermined indicator bit which is set to be a first predetermined field if the base station does not need to re-allocate the retransmission region, to indicate that a starting location of the retransmission region is the same as a frequency domain starting location of the persistent scheduling region.

5. The method according to claim 4, wherein the predetermined indicator bit is set to be a second predetermined field if the base station needs to re-allocate the retransmission region, to indicate that the starting location of the retransmission region is not the same as the starting location of the persistent scheduling region.

6. The method according to claim 5, wherein the attribute information of the retransmission region further comprises following parameter information: the starting location of the retransmission region and the number of the logical resource units occupied by the retransmission region, wherein the starting location comprises at least one of an index of a first logical resource unit occupied by the retransmission region and a subframe offset of the first logical resource unit occupied by the retransmission region.

7. The method according to claim 5, wherein the attribute information further comprises following parameter information: identification number of the retransmission region.

8. The method according to claim 3, wherein the adaptability indicator comprises a predetermined indicator bit which is set to be a third predetermined field to indicate that an attribute of a retransmission data packet is the same as that of a corresponding initial transmission data packet, wherein the attribute of the initial transmission data packet comprises at least one of a modulation and coding mode of the data packet and the number of logical resource units occupied.

9. The method according to claim 8, wherein after the base station sending the retransmission attribute information, the method further comprising: the terminal that has received informed retransmission attribute information, determining a location occupied by the terminal in the retransmission region for receiving or sending the retransmission data packet according to the corresponding relation stored thereby and the retransmission bitmap indicator information.

10. The method according to claim 3, wherein the adaptability indicator comprises a predetermined indicator bit which is set to be a fourth predetermined field to indicate whether an attribute of a retransmission data packet is not the same as that of a corresponding initial transmission data packet, and then the retransmission attribute information further comprises attribute change information of retransmission data, wherein the attribute change information of the retransmission data comprises at least one of the number of the logical resource blocks occupied by each retransmission data packet and a modulation and coding mode indicator of the each retransmission data packet.

11. The method according to claim 10, wherein after the base station sending the retransmission attribute information, the method further comprises:
the terminal that has received the retransmission attribute information determining a location in the retransmission region where the terminal receives or sends the retransmission data packet according to the retransmission bitmap indicator information and the attribute change information of the retransmission data.

12. The method according to claim 10, wherein the attribute information of the retransmission data further comprises at least one of an offset of a starting location of a each retransmission data packet with respect to the starting location of the retransmission region, a version number of the each retransmission data packet and an identifier of a terminal corresponding to the each retransmission data packet.

13. (canceled)

14. The method according to claim 1 wherein the retransmission region is located on a designated subframe of a synchronous HARQ in time domain, and is configured to transmit data packets that failed to be transmitted by the persistent scheduling service.

15. (canceled)

16. The method according to claim 1, wherein the control signaling comprises at least one of persistent allocation retransmission resource mapping information elements in a resource allocation mapping message and persistent allocation resource mapping information elements in the resource allocation mapping message.

17. The method according to claim 2, wherein the retransmission region is located on a designated subframe of a synchronous HARQ in time domain, and is configured to transmit data packets that failed to be transmitted by the persistent scheduling service.

18. The method according to claim 9, wherein the retransmission region is located on a designated subframe of a synchronous HARQ in time domain, and is configured to transmit data packets that failed to be transmitted by the persistent scheduling service.

19. The method according to claim 11, wherein the retransmission region is located on a designated subframe of a synchronous HARQ in time domain, and is configured to transmit data packets that failed to be transmitted by the persistent scheduling service.

20. The method according to claim 2, wherein the control signaling comprises at least one of persistent allocation retransmission resource mapping information elements in a resource allocation mapping message and persistent allocation resource mapping information elements in the resource allocation mapping message.

21. The method according to claim 9, wherein the control signaling comprises at least one of persistent allocation retransmission resource mapping information elements in a resource allocation mapping message and persistent allocation resource mapping information elements in the resource allocation mapping message.

22. The method according to claim 11, wherein the control signaling comprises at least one of persistent allocation retransmission resource mapping information elements in a resource allocation mapping message and persistent allocation resource mapping information elements in the resource allocation mapping message.
